(19) United States
(12) Patent Application Publication
(10) Pub. No.: US 2012/0019713 A1
(43) Pub. Date: Jan. 26, 2012

(54) MEMS-BASED APERTURE AND SHUTTER

(75) Inventors: Sauri Gudlavalleti, Machilipatnam (IN); Manish Kothari, Cupertino, CA (US)

(73) Assignee: QUALCOMM MEMS TECHNOLOGIES, INC., San Diego, CA (US)

(21) Appl. No.: 12/843,716

(22) Filed: Jul. 26, 2010

(51) Int. Cl. H04N 5/238; H04N 5/235

(52) U.S. Cl. 348/366; 348/362; 348/367; 348/E05.04

(57) ABSTRACT

Some embodiments comprise at least one array that includes microelectromechanical systems (“MEMS”)-based light-modulating devices. Elements of the array(s) may be configured to absorb and/or reflect light when in a first configuration and to transmit light when in a second position. Such an array may be controlled to function as a camera aperture and/or as a camera shutter. For example, a controller may cause the array to function as a shutter by causing the MEMS devices to open for a predetermined period of time. The predetermined period of time may be based, at least in part, on input received from a user, the intensity of ambient light, the intensity of a flash, the size of the camera aperture, etc. Some embodiments provide a variable aperture device that does not add significant thickness or cost to a camera module. Such embodiments may enable a camera to function well in both bright and dark light, to control depth of field, etc.

### FIELD OF THE INVENTION

This application relates generally to cameras and more specifically to camera apertures and camera shutters.

### BACKGROUND OF THE INVENTION

Miniature digital cameras have become very common features of personal computing devices such as mobile phones. These cameras typically have fixed apertures, because mechanical aperture plates are too large, too thick and/or too expensive for inclusion in small cameras of this type. These fixed apertures are generally small, because small apertures are suitable for taking photos in conditions of bright ambient light, e.g., outdoors. While a large aperture would be suitable for taking pictures in dim light, a fixed large aperture would not be appropriate for bright light conditions. Therefore, camera manufacturers implement small fixed apertures rather than large fixed apertures in miniature digital cameras, making the cameras unsatisfactory indoors or under other low-light conditions.

Such miniature cameras also lack mechanical shutters due to the same form-factor and cost limitations. As a result, these cameras generally use electronic switching, such as complementary metal-oxide-semiconductor (“CMOS”) switching, to control exposure time. This does not work very well for high-megapixel cameras, in part because the large amounts of data involved make it difficult to transfer the information collected by the sensor to memory quickly enough.

### SUMMARY

Some embodiments comprise at least one array that includes microelectromechanical systems (“MEMS”)-based light-modulating devices. Elements of the array(s) may be configured to absorb and/or reflect light when in a first configuration and to transmit light when in a second position. Such MEMS devices may have a fixed optical stack on a substantially transparent substrate and a movable mechanical stack or “plate” disposed at a predetermined air gap from the fixed stack. The optical stacks may be chosen such that when the movable stack is “up” or separated from the fixed stack, most light entering the substrates passes through the two stacks and air gap. When the movable stack is down, or close to the fixed stack, the combined stack may allow only a negligible amount of light to pass through.

Such an array may be controlled to function as a camera aperture and/or as a camera shutter. For example, a controller may cause the array to function as a shutter by causing the MEMS devices to open for a predetermined period of time. The predetermined period of time may be based, at least in part, on the intensity of ambient light, the intensity of a flash, the size of the camera aperture, etc. Some embodiments provide a variable aperture device that does not add significant thickness or cost to a camera module. Such embodiments may enable a camera to function well in both bright and dark light, to control depth of field, etc.

According to some such embodiments, the MEMS devices in a group may be gang-driven instead of being individually controlled. In such embodiments, the camera flash system may comprise a simple and relatively inexpensive controller for this purpose, as compared with a controller that is configured to individually control each MEMS device in the array.

In some embodiments, the array(s) may be controlled to allow partial transmission and partial reflection and/or absorption of light. For example, in some such embodiments, the array(s) may include a separate layer of material that can be made relatively more transmissive or relatively more absorptive. Accordingly, such embodiments may allow areas of an array that includes MEMS-based light-modulating devices to be only partially transmissive instead of substantially transmissive or substantially non-transmissive.

Some embodiments described herein provide a camera that includes a lens system, a first light detector, a first array and a controller. The first light detector may be configured to receive incoming light from the lens system. The first array may be configured to reflect or absorb incident light. The first array may comprise a first plurality of MEMS devices configured to reflect or absorb incident light when in a first position and to transmit incident light when in a second position. The controller may be configured to control the incoming light received by the light detector by controlling the first array.

The controller may be further configured to drive at least some of the MEMS devices to the second position for a predetermined period of time. The camera may also include a second light detector configured to detect an ambient light intensity and to provide ambient light intensity data to the controller. The controller may be further configured to determine the predetermined period of time based, at least in part, on the ambient light intensity data.

The controller may be further configured to control the first array to function as a camera shutter and/or as a variable camera aperture. The camera may also include a second array, which may comprise a second plurality of MEMS devices. The controller may be further configured to control the second array to function as a variable camera aperture or as a camera shutter. The controller may be configured to control the first array or the second array to transmit varying amounts of light.

In some embodiments, the camera may be part of a mobile device. For example, the camera may be part of a mobile device that is configured for data and/or voice communication. Although MEMS-based mobile devices are described in detail herein, the cameras described herein may be made part of many other types of devices, including but not limited to mobile devices.

Some methods are also described herein. Some such methods include processes of controlling light received by a light detector via a lens system and of capturing images via the light received by the light detector. The controlling process may involve controlling a first array comprising a first plurality of MEMS devices that are configured to reflect or absorb incident light when in a first position and to transmit incident light when in a second position.

The controlling process may also involve driving at least some of the MEMS devices to the second position, e.g., for a predetermined period of time. The controlling process may involve controlling the first array to transmit varying amounts of light.

The method may also involve detecting an ambient light intensity and calculating the predetermined period of time based, at least in part, on the ambient light intensity. The method may comprise controlling the first array to function as a camera shutter and/or as a variable camera aperture. The method may also involve controlling a second array to function as a variable camera aperture or as a camera shutter. The second array may comprise a second plurality of MEMS devices.

Alternative camera embodiments are described herein. Some such cameras include a lens system, an image capturing system and a light controlling system. The image capturing system may be configured to receive incoming light from the lens system. The light controlling system may be configured to reflect or absorb incident light when in a first position and to transmit incident light when in a second position.

The light controlling system may comprise a first array configured to function as a camera shutter. The first array may comprise a first plurality of MEMS devices. Alternatively, or additionally, the first array may be configured to function as a variable camera aperture. The light controlling system may also include a second array comprising a second plurality of MEMS devices. The second array may be configured to function as a variable camera aperture or as a camera shutter.

The functionality of the second array may depend on that of the first array. For example, if the first array is configured to function as a camera shutter, the second array may be configured to function as a camera aperture and vice versa.

These and other methods of the invention may be implemented by various types of devices, systems, components, software, firmware, etc. For example, some features of the invention may be implemented, at least in part, by computer programs embodied in machine-readable media. Some such computer programs may, for example, include instructions for determining which areas of the array(s) will be substantially transmissive, which areas will be substantially non-transmissive and/or which areas will be configured for partial transmission. Such computer programs may include instructions for controlling elements of a camera as described herein, including but not limited to instructions for controlling camera elements that include MEMS arrays.

### BRIEF DESCRIPTION OF THE DRAWINGS

FIGS. 1A and 1B depict a simplified version of a MEMS-based light-modulating device configured to absorb and/or reflect light when in a first position and to transmit light when in a second position.

FIG. 1C is an isometric view depicting a portion of one embodiment of an interferometric modulator array in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator array.

FIG. 3 is a diagram of movable mirror position versus applied voltage for one embodiment of an interferometric modulator such as those depicted FIG. 1C.

FIG. 4 is an illustration of a set of row and column voltages that may be used to drive an interferometric modulator array.

FIG. 5A illustrates one configuration of the 3×3 interferometric modulator array of FIG. 2.

FIG. 5B illustrates an example of a timing diagram for row and column signals that may be used to cause the configuration of FIG. 5A.

FIG. 6A is a schematic cross-section of an embodiment of an electrostatically actuatable modulator device comprising two or more conductive layers.

FIG. 6B is a plot of the transmission and reflection of the modulator device of FIG. 6A as a function of wavelength for two air gap heights.

FIG. 6C is a schematic cross-section of an embodiment comprising a modulator device and an additional device.

FIG. 7A depicts an array of MEMS-based light-modulating devices in a closed position.

FIG. 7B depicts the array of MEMS devices of FIG. 7A, some of which are in a closed position and some of which are in an open position.

FIG. 7C depicts another array of MEMS devices configured to function as a camera aperture.

FIG. 7D is a plot of area versus f-number for the array of MEMS devices depicted in FIG. 7C.

FIG. 8A depicts a camera assembly having a MEMS-based shutter.

FIG. 8B depicts a camera assembly having a MEMS-based shutter and a MEMS-based aperture.

FIG. 8C depicts a camera assembly having a MEMS-based device that combines the functionality of a shutter and an aperture.

FIG. 9 is a block diagram that depicts some components of a camera having a MEMS-based shutter and aperture.

FIGS. 10A and 10B are front and rear views of a camera having a MEMS-based shutter and/or aperture.

FIG. 10C is a front view of a mobile device having a MEMS-based shutter and/or aperture.

FIG. 10D is a back view of a mobile device having a MEMS-based shutter and/or aperture.

FIG. 10E is a block diagram that illustrates components of a mobile device such as that shown in FIGS. 10C and 10D.

FIG. 11 is a flow chart that outlines steps of some methods described herein.

FIG. 12 is a flow chart that outlines steps of alternative methods described herein.

### DETAILED DESCRIPTION

While the present invention will be described with reference to a few specific embodiments, the description and specific embodiments are merely illustrative of the invention and are not to be construed as limiting. Various modifications can be made to the described embodiments. For example, the steps of methods shown and described herein are not necessarily performed in the order indicated. It should also be understood that the methods shown and described herein may include more or fewer steps than are indicated. In some implementations, steps described herein as separate steps may be combined. Conversely, what may be described herein as a single step may be implemented as multiple steps.

Similarly, device functionality may be apportioned by grouping or dividing tasks in any convenient fashion. For example, when steps are described herein as being performed by a single device (e.g., by a single logic device), the steps may alternatively be performed by multiple devices and vice versa.

MEMS interferometric modulator devices may include a pair of reflective layers positioned at a variable and controllable distance from each other to form a resonant optical gap with at least one variable dimension. This gap may be sometimes referred to herein as an “air gap,” although gases or liquids other than air may occupy the gap in some embodiments. Some embodiments comprise an array that includes MEMS-based light-modulating devices. The array may be configured to absorb and/or reflect light when in a first configuration and to transmit light when in a second position.

According to some embodiments described herein, a camera may an array of MEMS devices that are configured to function as a camera shutter, as a camera aperture, or both. A controller may control the array to transmit light through, or substantially prevent the transmission of light through, predetermined areas of the array. When the array is controlled to function as a camera aperture, the size of the transmissive portion of the array may be controlled in response to input from a user, in response to detected ambient light conditions, etc. When the array is controlled to function as a camera shutter, the time interval during which at least a portion of the area is made transmissive may be controlled in response to input from a user, in response to detected ambient light conditions, in response to the aperture size, etc.

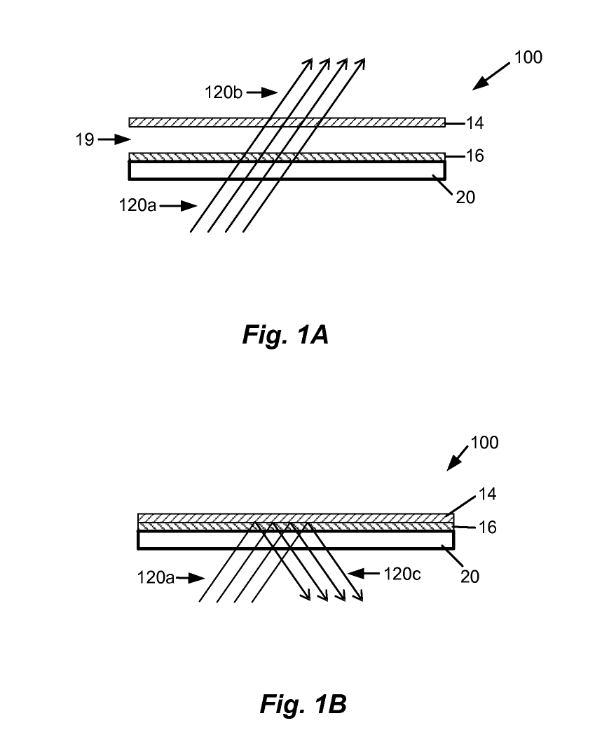

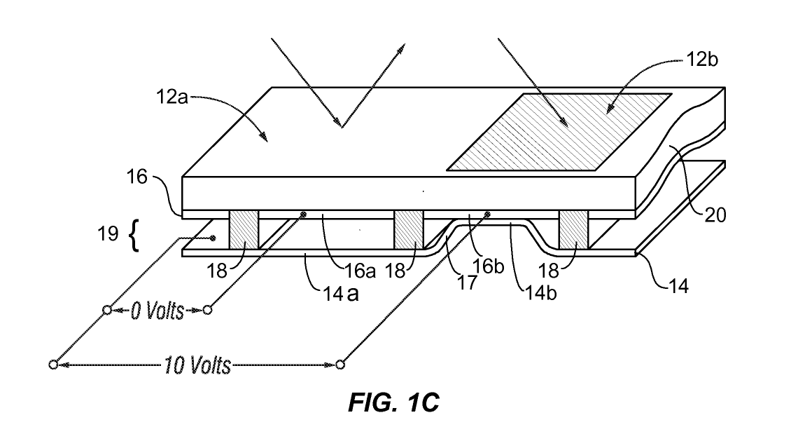

A simplified example of a MEMS-based light-modulating device that may form part of such an array is depicted in FIGS. 1A and 1B. In this example, MEMS interferometric modulator device 100 includes fixed optical stack 16 that has been formed on substantially transparent substrate 20. Movable reflective layer 14 may be disposed at a predetermined gap 19 from the fixed stack.

In some embodiments, movable reflective layer 14 may be moved between two positions. In the first position, which may be referred to herein as a relaxed position, the movable reflective layer 14 is positioned at a relatively large distance from a fixed partially reflective layer. The relaxed position is depicted in FIG. 1A. In the second position, referred to herein as the actuated position, the movable reflective layer is positioned more closely adjacent to the partially reflective layer. Alternative embodiments may be configured in a range of intermediate positions between the actuated position and the relaxed position.

The optical stacks may be chosen such that when the movable stack 14 is “up” or separated from the fixed stack 16, most visible light 120a that is incident upon substantially transparent substrate 20 passes through the two stacks and air gap. Such transmitted light 120b is depicted in FIG. 1A. However, when the movable stack 14 is down, or close to the fixed stack 16, the combined stack allows only a negligible amount of visible light to pass through. In the example depicted in FIG. 1B, most visible light 120a that is incident upon substantially transparent substrate 20 re-emerges from substantially transparent substrate 20 as reflected light 120b.

Depending on the embodiment, the light reflectance properties of the “up” and “down” states may be reversed. MEMS pixels and/or subpixels can be configured to reflect predominantly at selected colors, in addition to black and white. Moreover, in some embodiments, at least some visible light 120a that is incident upon substantially transparent substrate 20 may be absorbed. In some such embodiments, MEMS device 100 may be configured to absorb most visible light 120a that is incident upon substantially transparent substrate 20 and/or configured to partially absorb and partially transmit such light. Some such embodiments are discussed below.

FIG. 1C is an isometric view depicting two adjacent subpixels in a series of subpixels, wherein each subpixel comprises a MEMS interferometric modulator. In some embodiments, a MEMS array comprises a row/column array of such subpixels. Incident light that reflects from the two layers interferes constructively or destructively depending on the position of the movable reflective layer, producing either an overall reflective or non-reflective state for each subpixel or subpixel.

The depicted portion of the subpixel array in FIG. 1C includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

In some embodiments, the optical stacks 16a and 16b (collectively referred to as optical stack 16) may comprise several fused layers, which can include an electrode layer, such as indium tin oxide (ITO), a partially reflective layer, such as chromium, and a transparent dielectric. The optical stack 16 is thus electrically conductive, partially transparent, and partially reflective. The optical stack 16 may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row or column electrodes. For example, the movable reflective layers 14a, 14b may be formed as a series of parallel strips of a deposited metal layer or layers (which may be substantially orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a MEMS array.

With no applied voltage, the gap 19 remains between the movable reflective layer 14a and optical stack 16a, with the movable reflective layer 14a in a mechanically relaxed state, as illustrated by the subpixel 12a in FIG. 1C. However, when a potential difference is applied to a selected row and column, the capacitor formed at the intersection of the row and column electrodes at the corresponding subpixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by subpixel 12b on the right in FIG. 1C. The behavior may be the same regardless of the polarity of the applied potential difference.

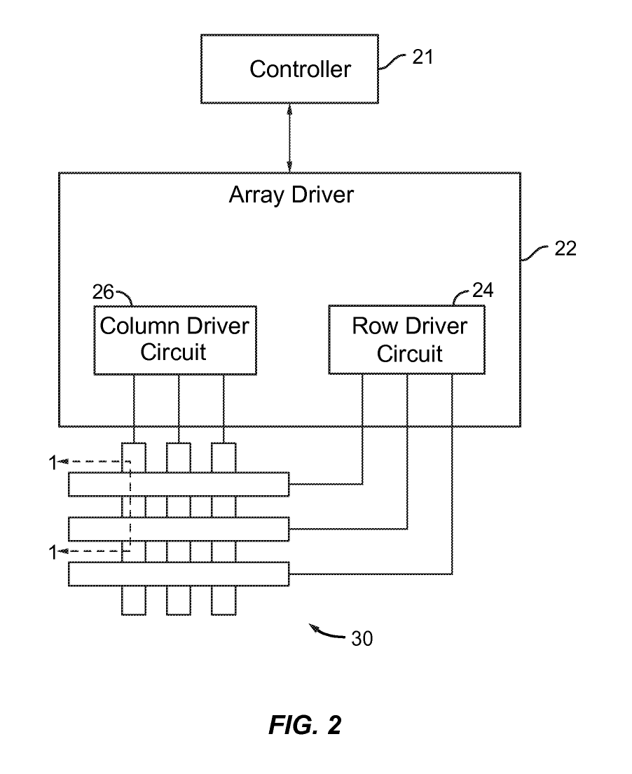

FIGS. 2 through 5B illustrate examples of processes and systems for using an array of interferometric modulators.

FIG. 2 is a system block diagram illustrating one embodiment of an electronic device that may incorporate aspects of the invention. In the exemplary embodiment, the electronic device includes a controller 21 which may comprise one or more suitable general purpose single- or multi-chip microprocessors such as an ARM, Pentium®, Pentium II®, Pentium III®, Pentium IV®, Pentium® Pro, an 8051, a MIPS®, a Power PC®, an ALPHA®, and/or any suitable special purpose logic device such as a digital signal processor, an application-specific integrated circuit (“ASIC”), a microcontroller, a programmable gate array, etc. The controller 21 may be configured to execute one or more software modules. In addition to executing an operating system, controller 21 may be configured to execute one or more software applications, such as software for executing methods described herein.

In one embodiment, the controller 21 is also configured to communicate with an array driver 22. In one embodiment, the array driver 22 includes a row driver circuit 24 and a column driver circuit 26 that provide signals to an array or panel 30, which is a MEMS array in this example. The cross section of the MEMS array illustrated in FIG. 1C is shown by the lines 1-1 in FIG. 2.

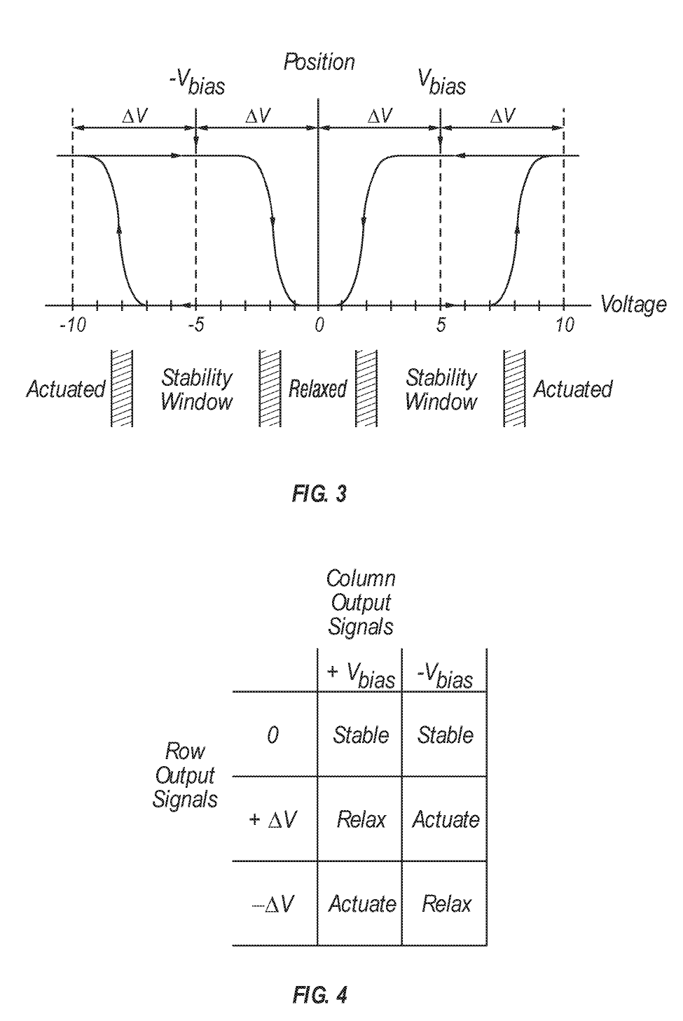

The row/column actuation protocol may take advantage of a hysteresis property of MEMS interferometric modulators that is illustrated in FIG. 3. It may require, for example, a 10 volt potential difference to cause a movable layer to deform from the relaxed state to the actuated state. However, when the voltage is reduced from that value, the movable layer can maintain its state as the voltage drops back below 10 volts. In the example of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.”

For a MEMS array having the hysteresis characteristics of FIG. 3, the row/column actuation protocol can be designed such that during row strobing, subpixels in the strobed row that are to be actuated are exposed to a voltage difference of about 10 volts, and subpixels that are to be relaxed are exposed to a voltage difference of close to zero volts. After the strobe, the subpixels are exposed to a steady state voltage difference of about 5 volts such that they remain in whatever state the row strobe put them in. After being driven, each subpixel sees a potential difference within the “stability window” of 3-7 volts in this example.

This feature makes the subpixel design illustrated in FIG. 1C stable under the same applied voltage conditions in either an actuated or relaxed pre-existing state. Since each subpixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the subpixel if the applied potential is fixed.

Desired areas of a MEMS array may be controlled by asserting the set of column electrodes in accordance with the desired set of actuated subpixels in the first row. A row pulse may then be applied to the row 1 electrode, actuating the subpixels corresponding to the asserted column lines. The asserted set of column electrodes is then changed to correspond to the desired set of actuated subpixels in the second row. A pulse is then applied to the row 2 electrode, actuating the appropriate subpixels in row 2 in accordance with the asserted column electrodes. The row 1 subpixels are unaffected by the row 2 pulse, and remain in the state they were set to during the row 1 pulse. This may be repeated for the entire series of rows in a sequential fashion to produce the desired configuration.

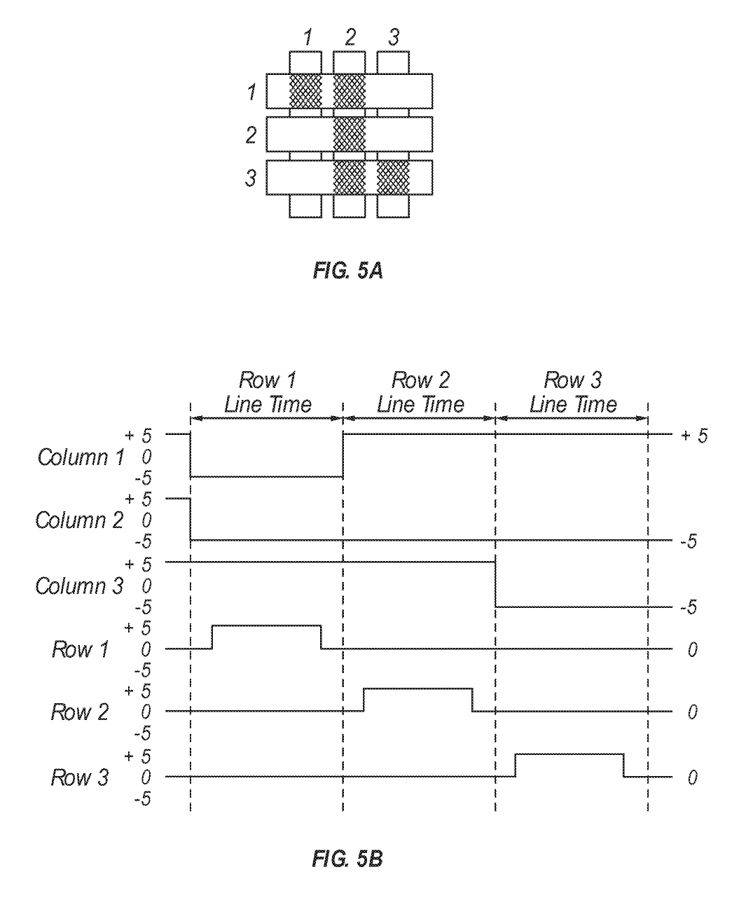

A wide variety of protocols for driving row and column electrodes of subpixel arrays may be used to control a MEMS array. FIGS. 4, 5A, and 5B illustrate one possible actuation protocol for controlling the 3×3 array of FIG. 2. FIG. 4 illustrates a possible set of column and row voltage levels that may be used for subpixels exhibiting the hysteresis curves of FIG. 3.

In the embodiment depicted in FIG. 4, actuating a subpixel involves setting the appropriate 5 column to −Vbias, and the appropriate row to +ΔV, which may correspond to −5 volts and +5 volts, respectively. Relaxing the subpixel is accomplished by setting the appropriate column to +Vbias, and the appropriate row to the same +ΔV, producing a zero volt potential difference across the subpixel. In those rows where the row voltage is held at zero volts, the subpixels are stable in whatever state they were originally in, regardless of whether the column is at +Vbias, or −Vbias. As is also illustrated in FIG. 4, it will be appreciated that voltages of opposite polarity than those described above can be used, e.g., actuating a subpixel can involve setting the appropriate column to +Vbias, and the appropriate row to −ΔV. In this embodiment, releasing the subpixel is accomplished by setting the appropriate column to −Vbias, and the appropriate row to the same −ΔV, producing a zero volt potential difference across the subpixel.

FIG. 5B is a timing diagram showing a series of row and column signals applied to the 3×3 array of FIG. 2 that will result in the arrangement illustrated in FIG. 5A, wherein actuated subpixels are non-reflective. Prior to being in the configuration illustrated in FIG. 5A, the subpixels can be in any state, and in this example, all the rows are at 0 volts, and all the columns are at +5 volts. With these applied voltages, all subpixels are stable in their existing actuated or relaxed states.

In the configuration depicted in FIG. 5A, subpixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any subpixels, because all the subpixels remain in the 3-7 volt stability window. Row 1 is then strobed with a pulse that goes from 0, up to 5 volts, and back to zero. This actuates the (1,1) and (1,2) subpixels and relaxes the (1,3) subpixel. No other subpixels in the array are affected. To set row 2 as desired, column 2 is set to −5 volts, and columns 1 and 3 are set to +5 volts. The same strobe applied to row 2 will then actuate subpixel (2,2) and relax subpixels (2,1) and (2,3). Again, no other subpixels of the array are affected. Row 3 is similarly set by setting columns 2 and 3 to −5 volts, and column 1 to +5 volts. The row 3 strobe sets the row 3 subpixels as shown in FIG. 5A. After writing the frame, the row potentials are zero, and the column potentials can remain at either +5 or −5 volts, and the array is then stable in the arrangement of FIG. 5A.

It will be appreciated that a similar procedure can be employed for arrays of dozens or hundreds of rows and columns. It will also be appreciated that the timing, sequence, and levels of voltages used to perform row and column actuation can be varied widely within the general principles outlined above. Moreover, it will be appreciated that the specific values and processes noted above are merely examples and that any suitable actuation voltage method can be used with the systems and methods described herein.

For example, in some camera-related embodiments described herein, groups of MEMS devices in predetermined areas of a MEMS array may be gang-driven instead of being individually controlled. These predetermined areas may, for example, comprise two or more groups of contiguous MEMS devices. A controller, such as a controller of a camera, a controller of a device that includes a camera, etc., may control the movable stack of each MEMS device in the group to be in substantially the same position (e.g., in the “up” or “down” position).

In some such embodiments, a camera system may comprise a simple and relatively inexpensive controller for this purpose, as compared with a controller that is configured to individually control each MEMS device in a MEMS array. In some embodiments, the controller may control the MEMS array in response to input from a user, in response to detected ambient light conditions. A shutter speed may be controlled, at least in part, according to aperture size and vice versa.

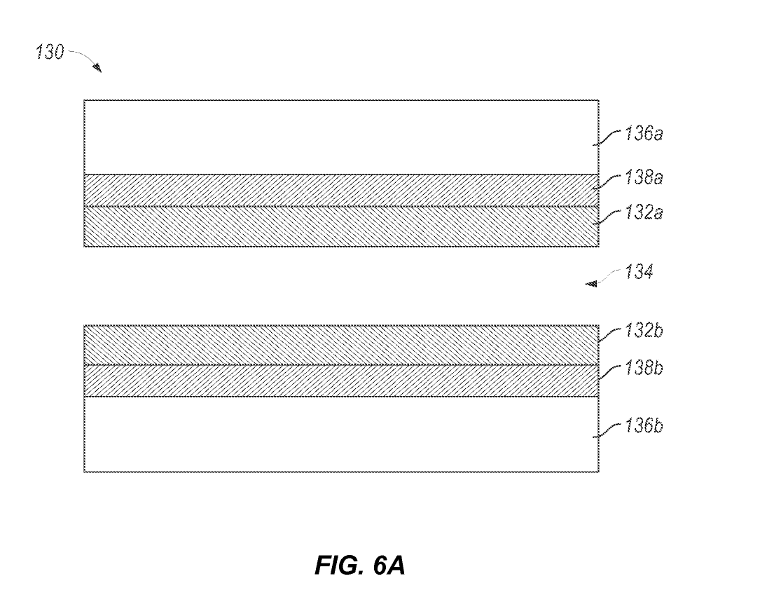

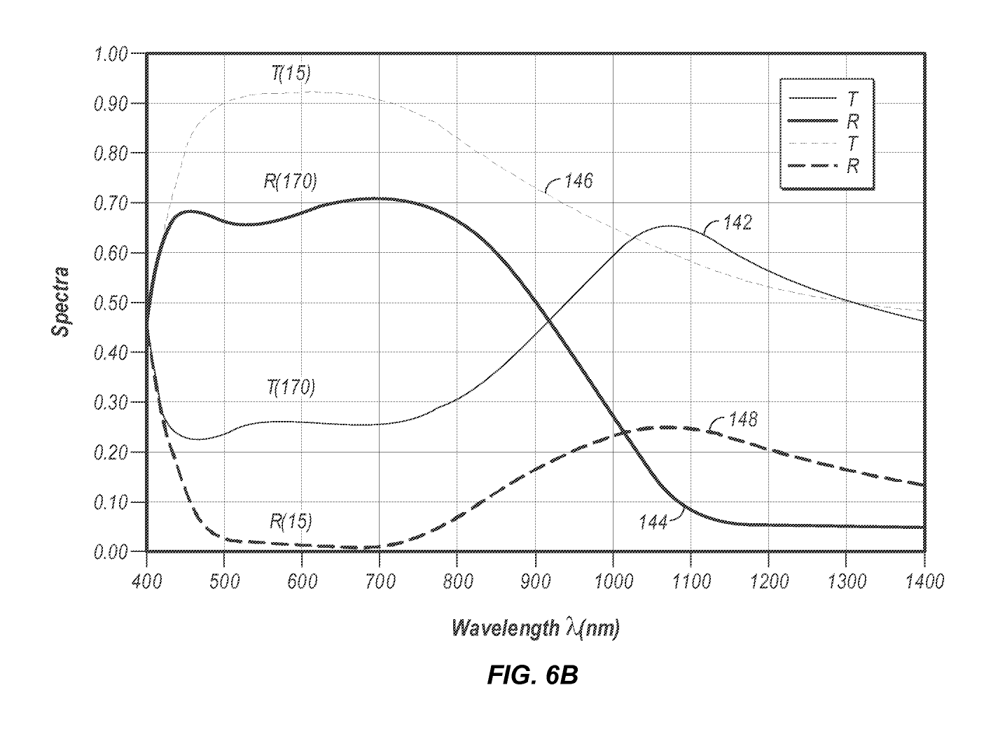

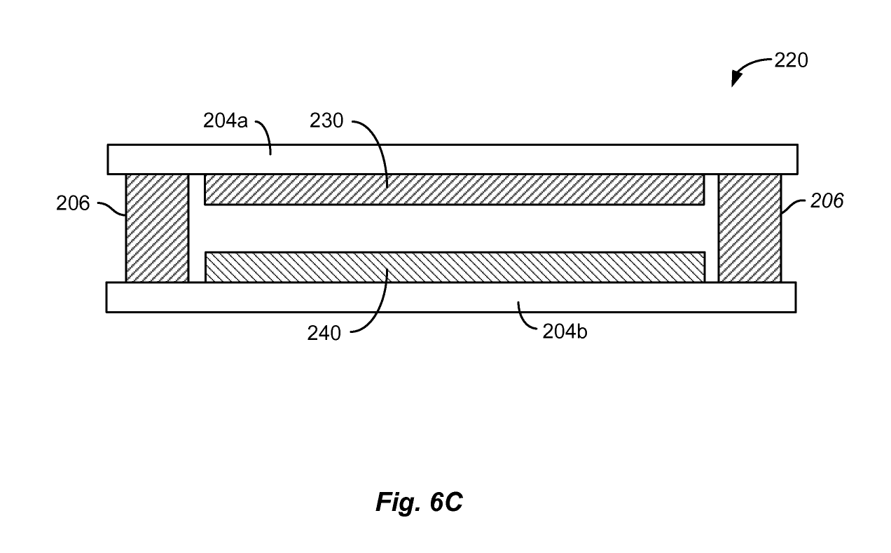

In some embodiments, a modulator device may include actuation elements integrated into the thin-film stack which permit displacement of portions of layers relative to one another so as to alter the spacing therebetween. FIG. 6A illustrates an exemplary modulator device 130 which is electrostatically actuatable. The device 130 includes a conductive layer 138a supported by a substrate 136a, and an optical layer 132a overlying the conductive layer 138a. Another conductive layer 138b is supported by substrate 136b and an optical layer 132b overlies the conductive layer 138b. The optical layer 132a and 132b are separated from one another by an air gap. Application of a voltage across conductive layers 138a and 138b will cause the one of the layers to deform towards the other one.

In some embodiments, the conductive layers 138a and 138b may comprise a transparent or light-transmissive material, such as indium tin oxide (ITO), for example, although other suitable materials may be used. The optical layers 132a and 132b may comprise a material having a high index of refraction. In some particular embodiments, the optical layers 132a and 132b may comprise titanium dioxide, although other materials may be used as well, such as lead oxide, zinc oxide, and zirconium dioxide, for example. The substrates may comprise glass, for example, and at least one of the substrates may be sufficiently thin to permit deformation of one of the layers towards the other.

In one embodiment in which the conductive layers 138a and 138b comprise ITO and are 80 nm in thickness, the optical layers 132a and 132b comprise titanium dioxide and are 40 nm in thickness, and the air gap is initially 170 nm in height. FIG. 6B illustrates plots across the visible and a portion of infrared wavelengths of the modeled transmission and reflectivity as a function of wavelength λ of the modulator device 130 both when the device is in an actuated state with an air gap of 15 nm and in an unactuated state with an air gap of 170 nm. The 15 nm air gap represents a fully actuated state, but surface roughness may in some embodiments prevent a further reduction in air gap size. In particular, line 142 illustrates the transmission as a function of wavelength when the device is in an unactuated position (T(170)), and line 144 illustrates the reflectivity in the same state (R(170)). Similarly, line 146 illustrates the transmission as a function of wavelength when the device is in an actuated position (T(15)), and line 148 illustrates the reflectivity in the actuated position (R(15)).

It can be seen from these plots that the modulator device 130 is highly transmissive across visible wavelengths when in an actuated state with a small air gap (15 nm), particularly for those wavelengths of less than about 800 nm. When in an unactuated state with a larger air gap (170 nm), the device becomes roughly 70% reflective to those same wavelengths. In contrast, the reflectivity and transmission of the higher wavelengths, such as infrared wavelengths, does not significantly change with actuation of the device. Thus, the modulator device 130 can be used to selectively alter the transmission/reflection of a wide range of visible wavelengths, without significantly altering the infrared transmission/reflection (if so desired).

FIG. 6C illustrates an embodiment of an apparatus 220, in which a first modulator device 230 is formed on a first substantially transparent substrate 204a, and a second device 240 is formed on a second substantially transparent substrate 204b. In one embodiment, the first modulator device 230 comprises a modulator device capable of switching between a state which is substantially transmissive to a wide range of visible radiation and another state in which the reflectance across a wide range of visible radiation is increased.

The second device 240 may in certain embodiments comprise a device which transmits a certain amount of incident light. In certain embodiments, the device 240 may comprise a device which absorbs a certain amount of incident light. In particular embodiments, the device 240 may be switchable between a first state which is substantially transmissive to incident light, and a second state in which the absorption of at least certain wavelengths is increased. In still other embodiment, the device 240 may comprise a fixed thin film stack having desired transmissive, reflective, or absorptive properties.

In certain embodiments, suspended particle devices (“SPDs”) may be used to change between a transmissive state and an absorptive state. These devices comprise suspended particles which in the absence of an applied electrical field are randomly positioned, so as to absorb and/or diffuse light and appear “hazy.” Upon application of an electrical field, these suspended particles may be aligned in a configuration which permits light to pass through.

Other devices 240 may have similar functionality. For example, in alternative embodiments, device 240 may comprise another type of “smart glass” device, such as an electrochromic device, micro-blinds or a liquid crystal device (“LCD”). Electrochromic devices change light transmission properties in response to changes in applied voltage. Some such devices may include reflective hydrides, which change from transparent to reflective when voltage is applied. Other electrochromic devices may comprise porous nano-crystalline films. In another embodiment, device 240 may comprise an interferometric modulator device having similar functionality.

Thus, when the device 240 comprises an SPD or a device having similar functionality, the apparatus 220 can be switched between three distinct states: a transmissive state, when both devices 230 and 240 are in a transmissive state, a reflective state, when device 230 is in a reflective state, and an absorptive state, when device 240 is in an absorptive state. Depending on the orientation of the apparatus 220 relative to the incident light, the device 230 may be in a transmissive state when the apparatus 220 is in an absorptive state, and similarly, the device 240 may be in a transmissive state when the apparatus 220 is in an absorptive state.

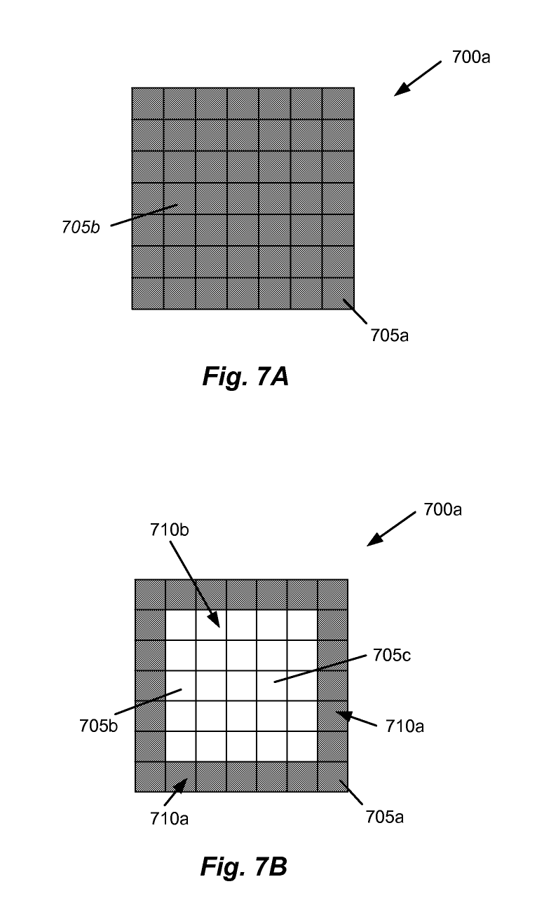

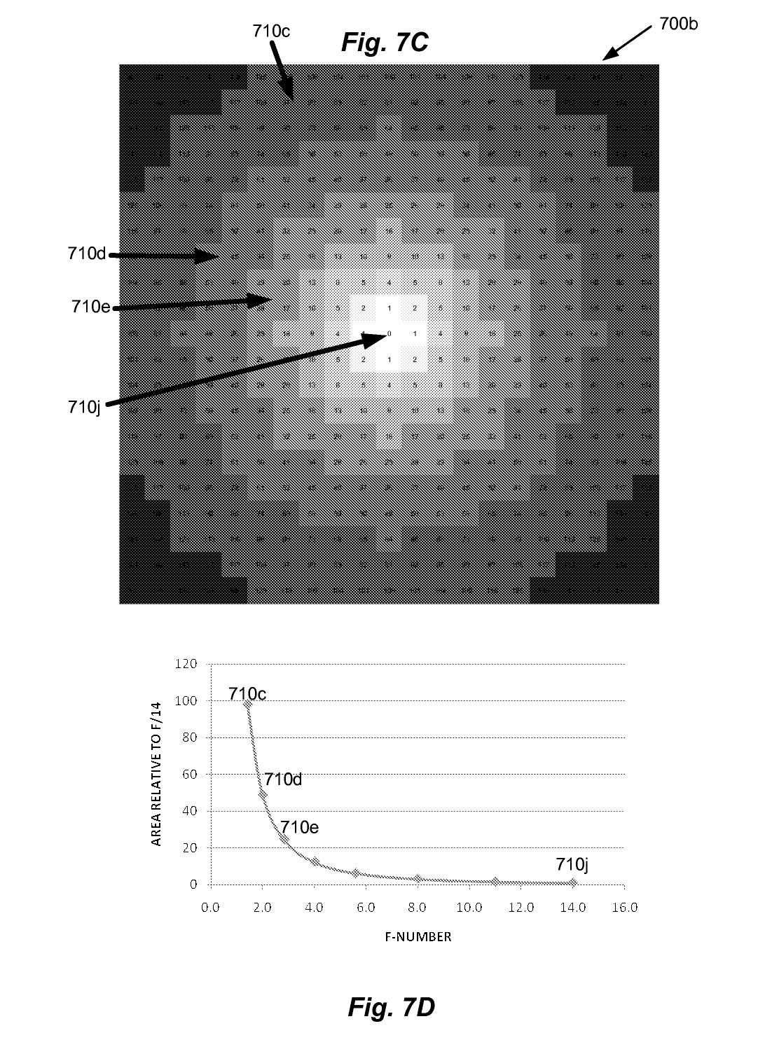

An array of MEMS devices that may be used for some embodiments described herein is depicted in FIGS. 7A-7C. Although such MEMS devices may be grouped into what may be referred to herein as a “MEMS array” or the like, some such MEMS arrays may include devices other than MEMS devices. For example, some MEMS arrays described herein may include non-MEMS devices, including but not limited to an SPD or a device having similar functionality, that are configured to selectively absorb or transmit light.

Referring first to FIG. 7A, array 700a is shown in a first configuration, in which array 700a is configured to block substantially all visible incident light. In this example, groups of individual MEMS devices of array 700a are controlled together. Here, each of cells 705 includes a plurality of individual MEMS devices, all of which are configured to be gang-driven by a controller. For example, each of the individual devices within cell 705a may be controlled as a group. Similarly, each of the individual devices within cell 705b will be controlled as a group. Array 700a may also include another type of device, such as an SPD or another “smart glass” device, which may be controlled to selectively absorb or transmit incident light.

Referring now to FIG. 7B, it will be observed that all of the cells within area 710a of array 700a, including cell 705a, are being controlled to block substantially all visible incident light. However, all of the cells within area 710b, including cell 705b, are being controlled to transmit substantially all visible incident light. In this example, fewer than 50 individual cells need to be individually controlled. Although alternative embodiments may involve controlling more or fewer cells, controlling individual devices within each cell as a group can greatly simplify the control system required for controlling a MEMS array.

Further simplifications may be introduced in other embodiments, for example, by controlling an entire row, column or other aggregation of cells 705 as a group. In some such embodiments, all of the cells 705 within area 710a may be controlled as a group. In some such embodiments, the devices with area 710a and/or other portions of array 700a may be organized into separately controllable cells 705, but alternative embodiments may not comprise separately controllable cells 705. In some embodiments, columns and/or rows of devices and/or cells 705 may be controlled as a group.

Some such arrays may be controlled to function as a variable camera aperture. In some such embodiments, each area of a plurality of areas of the array may be controlled as a group. Such embodiments may include a controller that is configured to drive such predetermined areas of the array to obtain predetermined f-stop settings for a camera aperture.

One example is provided in FIG. 7C, which depicts a 21×21 cell array. Each area 710 shown in array 700b as having a different shade of gray corresponds with a predetermined group of MEMS devices that can be individually driven or gang-driven. In this example, the 21×21 grid has 7 predetermined areas of MEMS devices, areas 710c through 710j, which can be gang-driven to achieve 7 levels of f-stopping. Other MEMS-based aperture arrays may have differing numbers of cells 705, areas 710, etc.

Data corresponding with areas 710c through 710j may, for example, be stored in a memory accessible by a camera controller and retrieved as needed to drive array 700b. Such aperture control enables satisfactory photographs to be taken in a variety of lighting conditions. Although the MEMS devices may be separately driven in alternative embodiments, simple and low-cost controllers may be used for gang-driving predetermined groups of MEMS devices corresponding to the predetermined areas.

FIG. 7D depicts a graph of f-number versus aperture area relative to f/14. The values for each of the 7 levels of f-stopping that may be achieved using the aperture of FIG. 7C are plotted on the graph. For example, it may be seen that area 710d of FIG. 7C corresponds with an f-number of f/2, whereas area 710j of FIG. 7C corresponds with an f-number of f/14.

In some embodiments, array 700b (or a similar array) may be controlled to achieve additional f-numbers. For example, if camera including such an array had a user interface for controlling aperture size, additional cells of array 700b may be made transmissive, reflective or absorptive to achieve a desired f-number. If a user were able to select certain f-numbers, such as f/2, a controller could cause area 710d of array 700b to be transmissive. However, if a user were able to select, e.g., f/3, a modified version of area 710e could be driven to more nearly match this f-number. For example, additional cells of area 710e could be made non-transmissive, such that the transmissive portion of area 710e would more closely correspond with an f-number of f/3. Alternative aperture array embodiments may have additional areas 710, to allow closer matching of additional f-numbers.

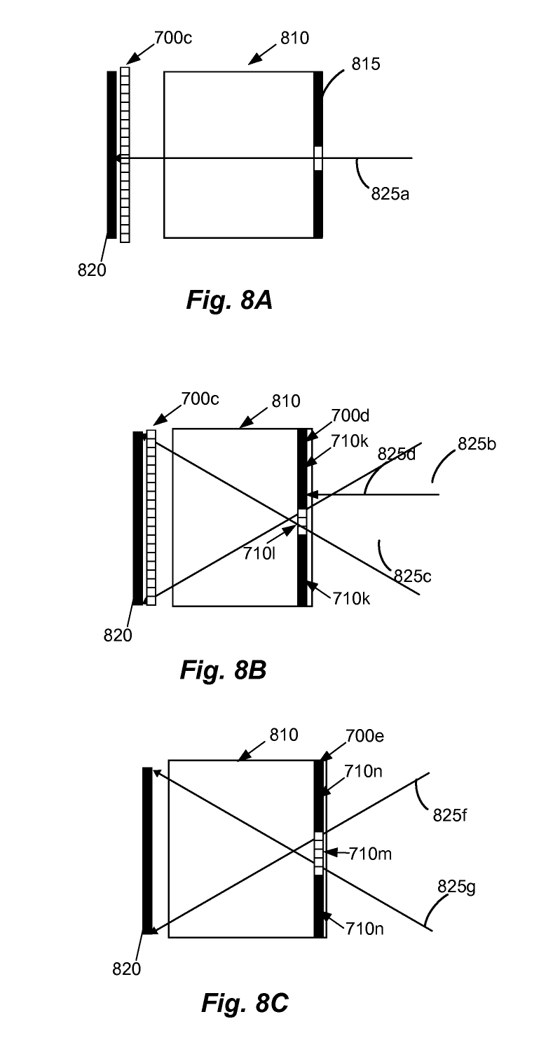

FIG. 8A is a schematic diagram of selected elements of a camera assembly. FIG. 8A depicts an embodiment wherein array 700c is configured to function as a camera shutter. In this example, camera lens assembly 810 includes a conventional camera aperture 815. However, in alternative embodiments, camera lens assembly 810 may include another array that is configured to function as a camera aperture.

Camera lens assembly 810 may include one or more lenses, filters, spacers or other such components. Depending on the implementation, camera lens assembly 810 may be made integral with another device, such as a mobile device. Alternatively, camera lens assembly 810 may be configured to be easily removed and replaced by a user. For example, a user may desire to have several camera lens assemblies 810 with different focal lengths or ranges of focal lengths.

At the moment depicted in FIG. 8A, some or all of the cells of shutter array 700c are temporarily in a transmissive “open shutter” condition. Accordingly, light ray 825a is able to reach image sensor 820 by passing through camera aperture 815, lens assembly 810 and shutter array 700c. Here, a camera controller has temporarily driven the cells of shutter array 700c to a transmissive state. The camera controller may have performed this action in response to receiving user input from a shutter control or other user input device. Some such shutter controls are described below. If the device that includes the camera has a flash assembly, the camera controller (or another such controller) may synchronize the open shutter condition of shutter array 700c with the activation of a light source in a camera flash assembly.

In some embodiments, the duration of time that the camera controller causes the cells of shutter array 700c to be in a transmissive condition may depend, at least in part, on the f-number of aperture 815. For example, in some embodiments the camera controller may be configured to receive user input regarding the f-number of aperture 815. The camera controller may use this input to determine, at least in part, the duration of time that the cells of shutter array 700c are in a transmissive condition.

In other embodiments, the camera controller may be configured to receive user input regarding the shutter speed of shutter array 700c. In some such embodiments, the camera controller may be configured to control aperture 815 according to user input regarding the shutter speed of shutter array 700c.

In alternative embodiments, camera aperture 815 may be fixed. The camera controller may use the f-number and/or other information regarding the fixed aperture to determine, at least in part, the duration of time that the cells of shutter array 700c will be in a transmissive condition.

Some embodiments may also include an ambient light sensor. The camera controller may use ambient light data from the ambient light sensor as well as camera aperture data to determine the duration of time that the cells of shutter array 700c are in a transmissive condition.

Although shutter array 700c is positioned near image sensor 820 in this example, other configurations may be used. For example, in some embodiments shutter array 700c may be positioned within lens assembly 810. In some embodiments shutter array 700c may be positioned in or near a focal plane of a camera assembly. In alternative embodiments, shutter array 700c may be positioned in front of lens assembly 810.

FIG. 8B is a schematic diagram of selected elements of an alternative camera assembly embodiment. FIG. 8B depicts an embodiment wherein array 700c is configured to function as a camera shutter and wherein array 700d is configured to function as a camera aperture. The arrangement of elements in FIG. 8B is made merely by way of example. In alternative implementations, array 700c and/or array 700d may be disposed in other portions of the camera assembly.

An aperture controller (which may or may not be the same controller that controls array 700c, according to the particular implementation) has temporarily controlled area 710k of aperture array 700d to be in a substantially non-transmissive state. For example, the aperture controller may have controlled one or more “smart glass” elements in area 710k to be in an absorptive state. Alternatively, or additionally, the aperture controller may have controlled cells in area 710k to be in a reflective condition with respect to visible light. Accordingly, light ray 825d and other light rays that are incident upon area 710k do not enter lens assembly 810.

However, the aperture controller has temporarily driven the cells within area 7101 of aperture array 700d to be a transmissive state. The cells of shutter array 700c are also driven by a controller to be temporarily in a transmissive “open shutter” condition. The shutter controller may, for example, have performed this action in response to receiving user input from a shutter control or other user input device. Accordingly, light ray 825b, light ray 825c and light rays at intermediate angles can pass through area 7101, lens assembly 810 and shutter array 700c to reach image sensor 820. (The refractive effects of lens assembly 810 on light rays are not indicated in the simplified examples described herein.) If the device that includes the camera has a flash assembly, the shutter controller (or another such controller) may synchronize the open shutter condition of shutter array 700c with the activation of a light source in a camera flash assembly.

In some embodiments, the aperture controller may be configured to receive user input regarding a desired f-number of array 700d. Based on a user's selection of f-number, an aperture controller may determine a corresponding manner of controlling array 700d. For example, the aperture controller may select a corresponding array control template from a plurality of predetermined array control templates stored in a memory. Each of the array control templates may indicate groups of array cells and how each of the groups is controlled to yield a predetermined result, such as a desired f-number.

In some embodiments, the duration of time that a camera controller causes the cells of shutter array 700c to be in a transmissive condition may depend, at least in part, on the f-number of array 700d. The camera controller may also use ambient light data from an ambient light sensor as well as camera aperture data to determine the duration of time that the cells of shutter array 700c are in a transmissive condition.

A camera controller may also be configured to receive user input regarding a desired shutter speed and may control array 700c according to this input. In some such embodiments, an aperture controller may control the f-number of array 700d according to a selected shutter speed. The controller may also use ambient light data from an ambient light sensor to determine an appropriate f-number for array 700d.

Array 700e of FIG. 8C is configured to function both as a camera shutter and as a camera aperture. A camera controller is controlling area 710n of array 700e to be in a substantially non-transmissive condition. At the moment depicted in FIG. 8C, the camera controller is temporarily controlling area 710m to be in a transmissive condition, thereby allowing light rays 825f and 825g (as well as light rays of intermediate angles) to pass through area 710m and lens assembly 810 to reach image sensor 820. At other times, area 710m is also maintained in a non-transmissive condition so that image sensor 820 is not continuously exposed to incoming light. Because light is only passing through area 710m when a photograph is being taken, such embodiments preferably include a separate optical pathway for a user to view the subject(s) to be photographed.

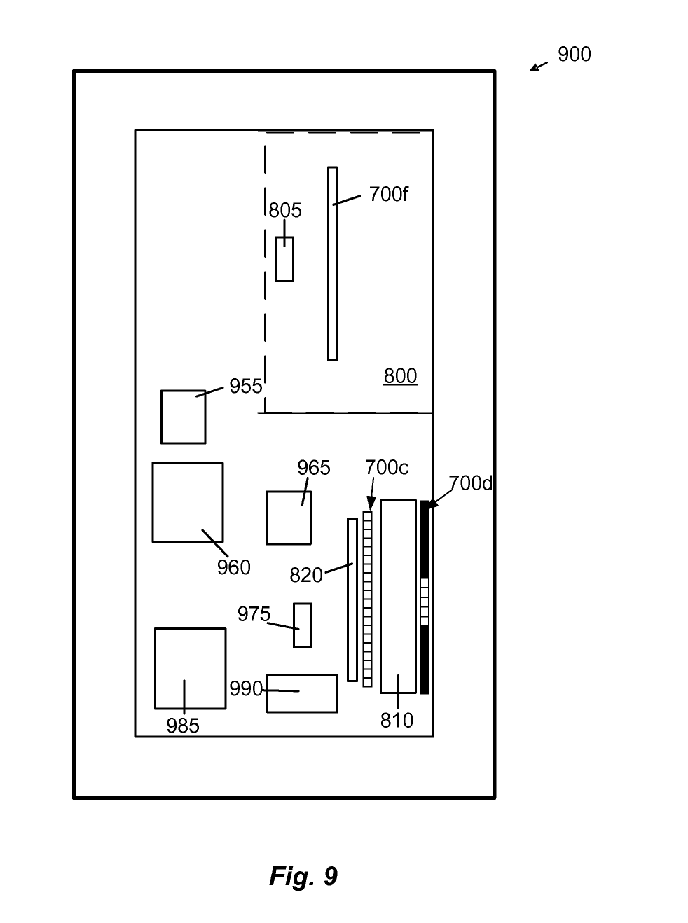

FIG. 9 is a block diagram that depicts components of a camera 900 according to some embodiments described herein. Camera 900 includes camera controller 960, which may include one or more general purpose or special purpose processors, logic devices, memory, etc. Camera controller 960 is configured to control various components of camera 900. For example, camera controller 960 controls the focal length, autofocus functionality (if any), etc., of lens system 810. Camera controller 960 is configured to control aperture array 700d to produce a desired aperture size. Moreover, camera controller 960 is configured to control the shutter speed, shutter timing, etc., of shutter array 700c, as well as the components of flash assembly 800.

Camera controller 960 may control at least some components of camera 900 according to input from user interface system 965. In some embodiments, user interface system 965 may include a shutter control such as a button or a similar device. User interface system 965 may include a display device configured to display images, graphical user interfaces, etc. In some such embodiments, user interface system 965 may include a touch screen.

User interface system 965 may have varying complexity, according to the specific embodiment. For example, in some embodiments, user interface system 965 may include an aperture control that allows a user to provide input regarding a desired aperture size. Camera controller 960 may control shutter array 700c according to aperture size input received from user interface system 965. Similarly, user interface system 965 may include a shutter control that allows a user to indicate a desired shutter speed. Camera controller 960 may control aperture array 700d according to shutter speed input received from user interface system 965. Camera controller 960 may control shutter array 700c and/or aperture array 700d according to ambient light data received from light sensor 975.

Camera flash assembly 800 includes light source 805 and flash array 700f. In this embodiment, camera flash assembly 800 does not have a separate controller. Instead, camera controller 960 controls camera flash assembly 800 of camera 900. Camera interface system 955 provides I/O functionality and transfers information between camera controller 960, camera flash assembly 800 and other components of camera 900. In alternative embodiments, camera flash assembly 800 also includes a flash assembly controller configured for controlling light source 805 and array 700f. Various MEMS-based embodiments of camera flash assembly 800 are described in U.S. application Ser. No. 12/836,872 (see, e.g., FIGS. 7A through 9B, 11A and 11B and the corresponding description), entitled “Camera Flash System Controlled Via MEMS Array (Attorney Docket No. QUALP026/100318U2), which is hereby incorporated by reference. However, in alternative embodiments, camera 900 may include a conventional camera flash assembly 800 that does not include a MEMS-based array.

In some embodiments, camera controller 960 may be configured to send control signals to camera flash assembly 800 regarding the appropriate configuration of flash array 700f and/or the appropriate illumination provided by light source 805. Moreover, camera controller 960 may be configured to synchronize the operation of camera flash assembly 800 with the operation of shutter array 700c.

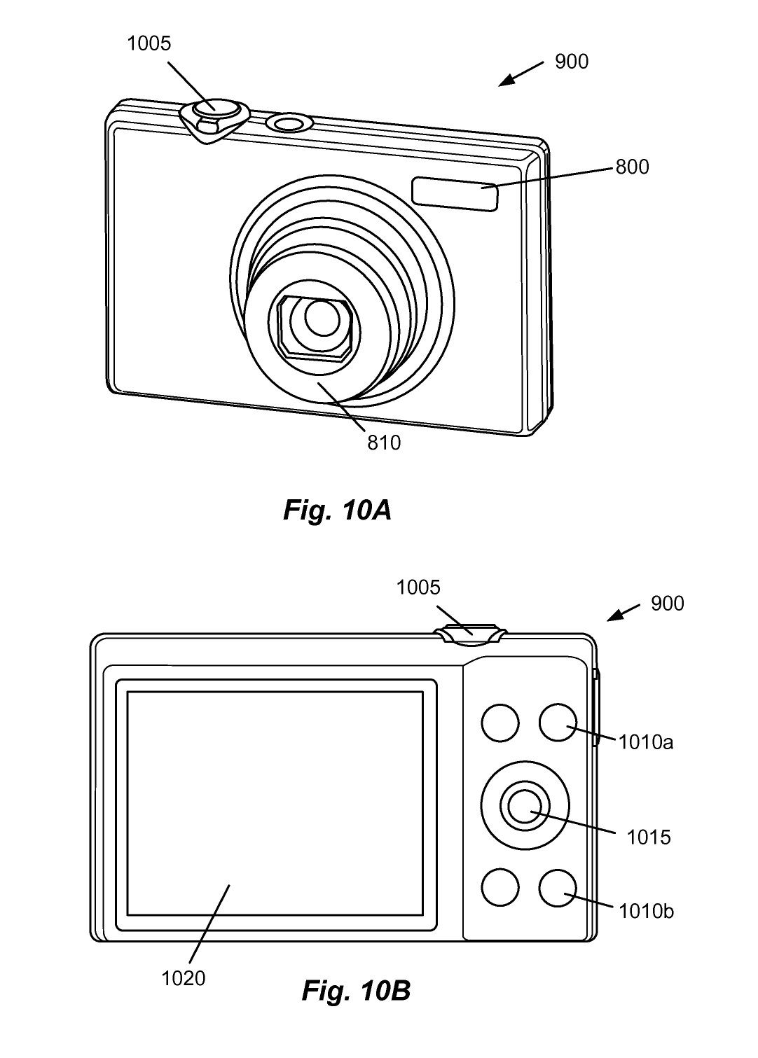

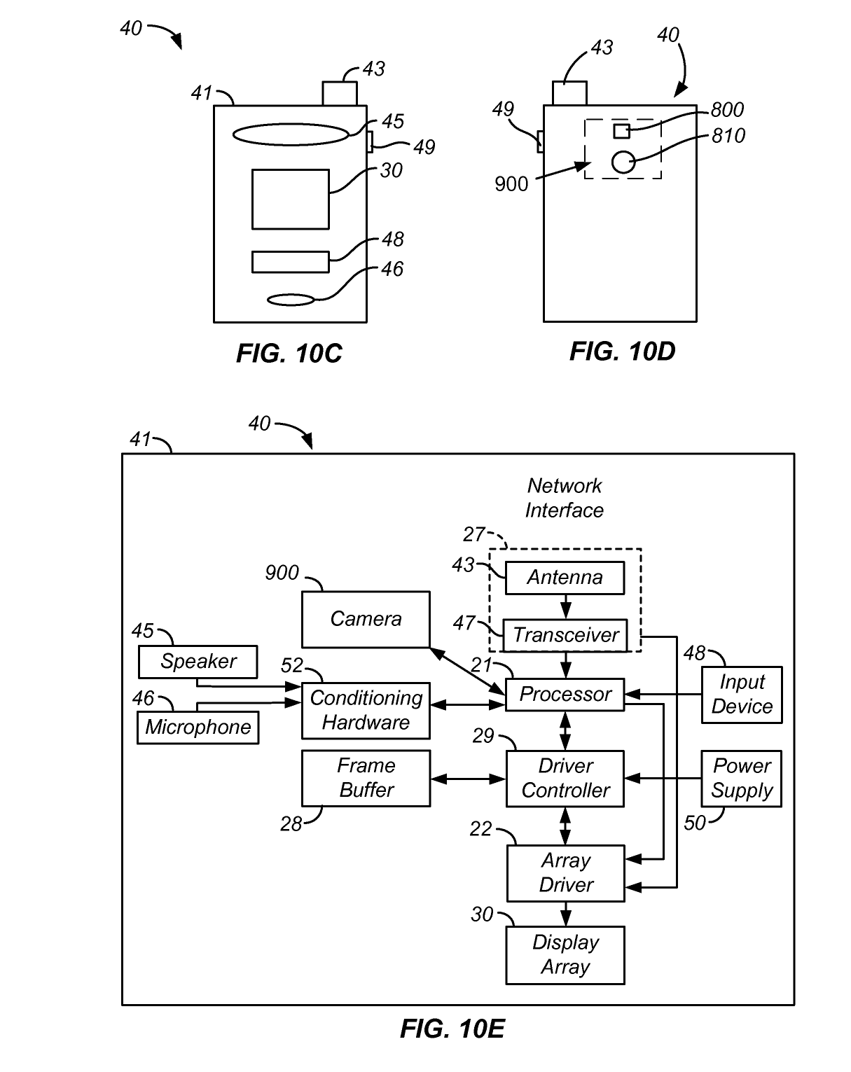

Images from lens system 810 may be captured on image sensor 820. Camera controller 960 may control a display, such as that depicted in FIG. 10B, to display images captured on image sensor 820. Data corresponding with such images may be stored in memory 985. Battery 990 provides power to camera 900.

FIG. 10A is a front view of one embodiment of camera 900. Here, lens system 810 includes a zoom lens. A front portion of camera flash assembly 800 is positioned in an upper portion of the front of camera 900 in this example.

Several components of camera 900 that are shown in FIGS. 10A through 10E, such as shutter control 1005, display 1020 and display 30, may be regarded as part of user interface system 965. Control buttons 1010a and 1010b, as well as menu control 1015, may also be regarded as part of user interface system 965. Display 1020 may be controlled via user interface system 965 to display images, graphical user interfaces, etc.

FIGS. 10C-10E are system block diagrams illustrating an embodiment of a display device 40 that includes a camera as provided herein. The display device 40 may be, for example, a portable device such as a cellular or mobile telephone, a personal digital assistant (“PDA″), etc. However, the same components of display device 40 or slight variations thereof are also illustrative of various types of display devices such as portable media players.

Referring now to FIG. 10C, a front side of display device 40 is shown. This example of display device 40 includes a housing 41, a display 30, an antenna 43, a speaker 45, an input system 48, a shutter control 49 and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 in this example of the display device 40 may be any of a variety of displays. Moreover, although only one display 30 is illustrated in FIG. 10C, display device 40 may include more than one display 30. For example, the display 30 may comprise a flat-panel display, such as plasma, an electroluminescent (EL) display, a light-emitting diode (LED) (e.g., organic light-emitting diode (OLED)), a transmissive display such as a liquid crystal display (LCD), a bi-stable display, etc. Alternatively, display 30 may comprise a non-flat-panel display, such as a cathode ray tube (CRT) or other tube device, as is well known to those of skill in the art. However, for the embodiments of primary interest in this application, the display 30 includes at least one transmissive display.

FIG. 10D illustrates a rear side of display device 40. In this example, camera 900 is disposed on an upper portion of the rear side of display device 40. Here, camera flash assembly 800 is disposed above lens system 810. Other elements of camera 900 are disposed within housing 41 and are not visible in FIG. 10D.

Components of one embodiment of display device 40 are schematically illustrated in FIG. 2. The illustrated display device 40 includes a housing 41 and can include additional components at least partially enclosed therein. For example, in one embodiment, the display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input system 48 and a driver controller 29. The driver controller 29 is coupled to a frame buffer 28 and to an array driver 22, which in turn is coupled to a display array 30. A power supply 50 provides power to all components as required by the particular display device 40 design.

The network interface 27 includes the antenna 43 and the transceiver 47 so that the display device 40 can communicate with one or more devices over a network. In some embodiments, the network interface 27 may also have some processing capabilities to relieve requirements of the processor 21. The antenna 43 may be any antenna known to those of skill in the art for transmitting and receiving signals. In one embodiment, the antenna is configured to transmit and receive RF signals according to an Institute of Electrical and Electronics Engineers (IEEE) 802.11 standard, e.g., IEEE 802.11(a), (b), or (g). In another embodiment, the antenna is configured to transmit and receive RF signals according to the BLUETOOTH standard. In the case of a cellular telephone, the antenna may be designed to receive Code Division Multiple Access (“CDMA”), Global System for Mobile communications (“GSM”), Advanced Mobile Phone System (“AMPS”) or other known signals that are used to communicate within a wireless cell phone network. The transceiver 47 may pre-process the signals received from the antenna 43 so that the signals may be received by, and further manipulated by, the processor 21. The transceiver 47 may also process signals received from the processor 21 so that the signals may be transmitted from the display device 40 via the antenna 43.

In an alternative embodiment, the transceiver 47 may be replaced by a receiver and/or a transmitter. In yet another alternative embodiment, network interface 27 may be replaced by an image source, which may store and/or generate image data to be sent to the processor 21. For example, the image source may be a digital video disk (DVD) or a hard disk drive that contains image data, or a software module that generates image data. Such an image source, transceiver 47, a transmitter and/or a receiver may be referred to as an “image source module” or the like.

Processor 21 may be configured to control the operation of the display device 40. The processor 21 may receive data, such as compressed image data from the network interface 27, from camera 900 or from another image source, and process the data into raw image data or into a format that is readily processed into raw image data. The processor 21 may then send the processed data to the driver controller 29 or to frame buffer 28 (or another memory device) for storage.

Processor 21 may control camera 900 according to input received from input device 48. When camera 900 is operational, images received and/or captured by lens system 810 may be displayed on display 30. Processor 21 may also display stored images on display 30. In some embodiments, camera 900 may include a separate controller for camera-related functions.

In one embodiment, the processor 21 may include a microcontroller, central processing unit (“CPU”), or logic unit to control operation of the display device 40. Conditioning hardware 52 may include amplifiers and filters for transmitting signals to the speaker 45, and for receiving signals from the microphone 46. Conditioning hardware 52 may be discrete components within the display device 40, or may be incorporated within the processor 21 or other components. Processor 21, driver controller 29, conditioning hardware 52 and other components that may be involved with data processing may sometimes be referred to herein as parts of a “logic system,” a “control system” or the like.

The driver controller 29 may be configured to take the raw image data generated by the processor 21 directly from the processor 21 and/or from the frame buffer 28 and reformat the raw image data appropriately for high speed transmission to the array driver 22. Specifically, the driver controller 29 may be configured to reformat the raw image data into a data flow having a raster-like format, such that it has a time order suitable for scanning across the display array 30. Then the driver controller 29 may send the formatted information to the array driver 22. Although a driver controller 29, such as a LCD controller, is often associated with the system processor 21 as a stand-alone integrated circuit (“IC”), such controllers may be implemented in many ways. For example, they may be embedded in the processor 21 as hardware, embedded in the processor 21 as software, or fully integrated in hardware with the array driver 22. An array driver 22 that is implemented in some type of circuit may be referred to herein as a “driver circuit” or the like.

The array driver 22 may be configured to receive the formatted information from the driver controller 29 and reformat the video data into a parallel set of waveforms that are applied many times per second to the plurality of leads coming from the display's x-y matrix of pixels. These leads may number in the hundreds, the thousands or more, according to the embodiment.

In some embodiments, the driver controller 29, array driver 22, and display array 30 may be appropriate for any of the types of displays described herein. For example, in one embodiment, driver controller 29 may be a transmissive display controller, such as an LCD display controller. Alternatively, driver controller 29 may be a bi-stable display controller (e.g., an interferometric modulator controller). In another embodiment, array driver 22 may be a transmissive display driver or a bi-stable display driver (e.g., an interferometric modulator display driver). In some embodiments, a driver controller 29 may be integrated with the array driver 22. Such embodiments may be appropriate for highly integrated systems such as cellular phones, watches, and other devices having small area displays. In yet another embodiment, display array 30 may comprise a display array such as a bi-stable display array (e.g., a display including an array of interferometric modulators).

The input system 48 allows a user to control the operation of the display device 40. In some embodiments, input system 48 includes a keypad, such as a QWERTY keyboard or a telephone keypad, a button, a switch, a touch-sensitive screen, or a pressure- or heat-sensitive membrane. In one embodiment, the microphone 46 may comprise at least part of an input system for the display device 40. When the microphone 46 is used to input data to the device, voice commands may be provided by a user for controlling operations of the display device 40.

Power supply 50 can include a variety of energy storage devices. For example, in some embodiments, power supply 50 may comprise a rechargeable battery, such as a nickel-cadmium battery or a lithium ion battery. In another embodiment, power supply 50 may comprise a renewable energy source, a capacitor, or a solar cell such as a plastic solar cell or solar-cell paint. In some embodiments, power supply 50 may be configured to receive power from a wall outlet.

In some embodiments, control programmability resides, as described above, in a driver controller which can be located in several places in the electronic display system. In some embodiments, control programmability resides in the array driver 22.

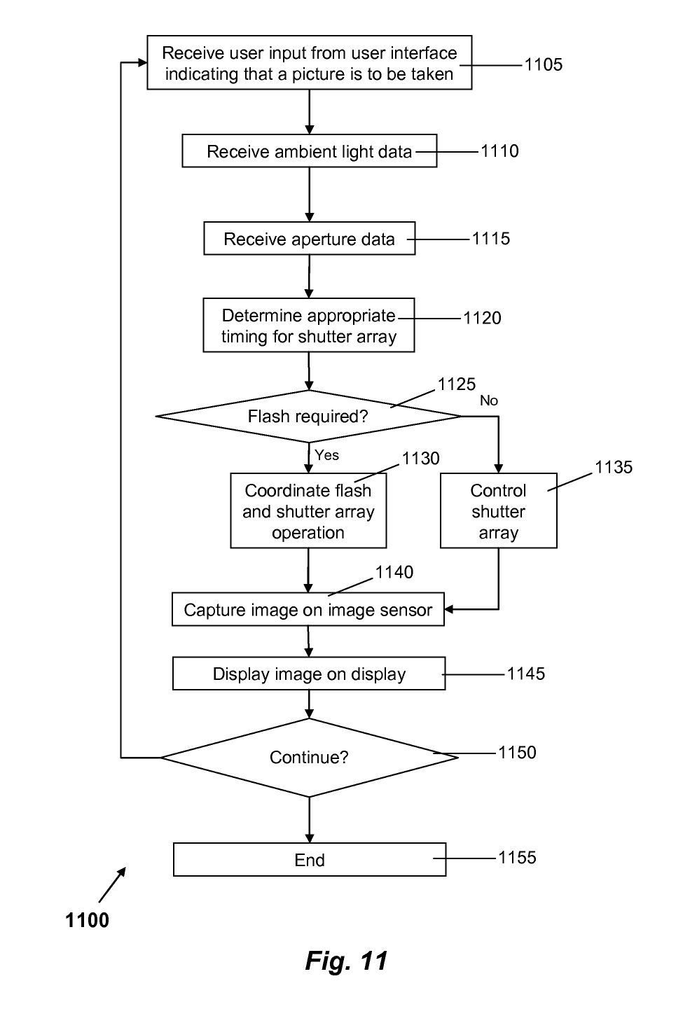

FIG. 11 is a flow chart that outlines steps of method 1100. Such a method may be performed, at least in part, by a controller such as camera controller 960 of FIG. 9 or by processor 21 of display device 40 (see FIGS. 10C-10E). In the example described below, steps are performed by camera controller 960. The steps of method 1100, like the steps of other methods provided herein, are not necessarily performed in the order indicated. Moreover, the methods described herein may include more or fewer steps than are indicated. In some implementations, steps described herein as separate steps may be combined. Conversely, what may be described herein as a single step may be implemented as multiple steps.

In step 1105, an indication is received by camera controller 960 from a user input device that a user wants to take a picture. For example, an indication may be received by camera controller 960 from shutter control 1005 of FIG. 10A that a user has depressed the shutter control. Camera controller 960 receives ambient light data from ambient light sensor 975 of FIG. 9 in this example. (Step 1110.)

In this example, user interface system 965 of FIG. 9 provides a physical control, a graphical user interface or another device configured to receive aperture data from a user. Accordingly, in step 1115, aperture data are received by camera controller 960 from user interface system 965. Here, camera controller 960 determines an appropriate shutter speed according to the aperture data and the ambient light data (step 1120).

In step 1125, camera controller 960 determines whether a flash would be appropriate. For example, if the shutter speed determined in step 1120 exceeds a predetermined threshold (such as ½ second, 1 second, etc.), camera controller 960 may determine that a flash would be appropriate. If so, step 1125 may also involve determining a revised shutter speed appropriate for the additional light contributed by the camera flash, given the aperture data.

In some embodiments, a user may be able to manually override use of the flash. For example, a user may intend to use a tripod or some other means of supporting the camera when a photograph is taken. If so, the user may not want the flash to operate when the picture is taken, even if the shutter will need to be open for a relatively long period of time.

If camera controller 960 determines in step 1125 that a flash should be used, camera controller 960 determines appropriate instructions for flash assembly 800 (such as the appropriate timing, intensity and duration of the flash(es) from light source 805) and coordinates the timing of the flash(es) with the operation of shutter array 700c. (Step 1130.) However, if camera controller 960 determines in step 1125 that a flash will not be used, camera controller 960 controls shutter array 700c (step 1135). An image is captured on image sensor 820 in step 1140.

In this example, the image captured in step 1140 is displayed on a display device in step 1145. The image may be deleted, edited, stored or otherwise processed according to input received from user input system 965. In step 1150, it will be determined whether the process will continue. For example, it may be determined whether input has been received from the user within a predetermined time, whether the user is powering off the camera, etc. In step 1155, the process ends.

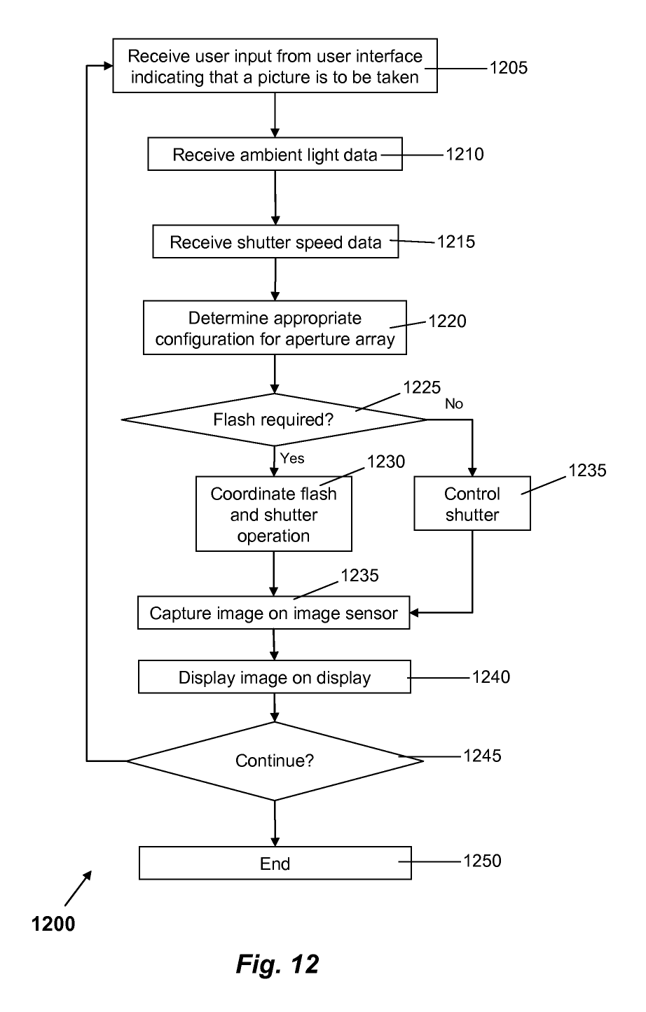

FIG. 12 is a flow chart that outlines steps of method 1200. In step 1205, an indication is received by a camera controller, such as camera controller 960, from a user input device that a user wants to take a picture. Here, camera controller 960 receives ambient light data from ambient light sensor 975 of FIG. 9. (Step 1210.)

In this example, user interface system 965 of FIG. 9 provides a physical control, a graphical user interface or another device configured to receive shutter speed data from a user. Accordingly, in step 1215, shutter speed data are received by camera controller 960 from user interface system 965. In some implementations, the camera shutter may comprise a shutter array such as shutter array 700c, but in alternative implementations the shutter may be a conventional shutter.

Here, camera controller 960 determines an appropriate aperture configuration according to the shutter speed data and the ambient light data (step 1220). For example, camera controller 960 may determine an appropriate aperture f-number according to the shutter speed data and the ambient light data. Camera controller 960 may query a memory structure that includes a plurality of predetermined aperture array control templates and corresponding f-numbers. Camera controller 960 may select an aperture array control template from the plurality of predetermined aperture array control templates that most closely matches the appropriate aperture f-number.

In step 1225, camera controller 960 determines whether a flash would be appropriate. If camera controller 960 determines in step 1225 that a flash will be used, camera controller 960 may determine whether the aperture array configuration determined in step 1220 would still be appropriate. If not, a new aperture array configuration may be determined. In alternative implementations, step 1225 may be performed prior to step 1220, so that only one process of determining aperture array configuration is performed for each iteration of method 1200.

If camera controller 960 has determined in step 1225 that a flash will be used, camera controller 960 determines appropriate instructions for flash assembly 800 and coordinates the timing of the flash(es) with the operation of the camera shutter. (Step 1230.) If camera controller 960 determines in step 1225 that a flash will not be used, camera controller 960 nonetheless controls the shutter in step 1235 according to the shutter speed data received in step 1215. An image is captured on image sensor 820. (Step 1240.)

In this example, the image captured in step 1240 is displayed on a display device in step 1245. In step 1250, it will be determined whether the process will continue. In step 1255, the process ends.

Although illustrative embodiments and applications are shown and described herein, many variations and modifications are possible which remain within the concept, scope, and spirit of the subject matter provided herein, and these variations should become clear after perusal of this application. For example, alternative MEMS devices and/or fabrication methods such as those described in U.S. application Ser. No. 12/255,423, entitled “Adjustably Transmissive MEMS-Based Devices” and filed on Oct. 21, 2008 (which is hereby incorporated by reference) may be used. Accordingly, the present embodiments are to be considered as illustrative and not restrictive, and the invention is not to be limited to the details given herein, but may be modified within the scope and equivalents of the appended claims.

We claim:

1. A camera, comprising:
a lens system;
a first light detector configured to receive incoming light from the lens system;
a first array configured to reflect or absorb incident light, the first array comprising a first plurality of microelectromechanical systems (“MEMS”) devices configured to reflect or absorb incident light when in a first position and to transmit incident light when in a second position; and
a controller configured to control the incoming light received by the light detector by controlling the first array.

2. The camera of claim 1, wherein the controller is further configured to drive at least some of the MEMS devices to the second position for a predetermined period of time.

3. The camera of claim 1, wherein the controller is further configured to drive a predetermined number of the MEMS devices to the second position.

4. The camera of claim 1, wherein the controller is further configured to control the first array to transmit varying amounts of light.

5. A mobile device comprising the camera of claim 1.

6. The camera of claim 2, further comprising a second light detector configured to detect an ambient light intensity and to provide ambient light intensity data to the controller, wherein the controller is further configured to determine the predetermined period of time based, at least in part, on the ambient light intensity data.

7. The camera of claim 2, wherein the controller is further configured to control the first array to function as a camera shutter.

8. The camera of claim 3, wherein the controller is further configured to control the first array to function as a variable camera aperture.

9. The camera of claim 5, wherein the mobile device is configured for data and voice communication.

10. The camera of claim 7, wherein the controller is further configured to control the first array to function as a variable camera aperture.

11. The camera of claim 7, further comprising a second array, the second array comprising a second plurality of MEMS devices, wherein the controller is further configured to control the second array to function as a variable camera aperture.

12. The camera of claim 8, wherein the controller is further configured to control the first array to function as a camera shutter.

13. The camera of claim 8, further comprising a second array, the second array comprising a second plurality of MEMS devices, wherein the controller is further configured to control the second array to function as a camera shutter.

14. A method, comprising:
controlling light received by a light detector via a lens system, the controlling process comprising controlling a first array comprising a first plurality of microelectromechanical systems (“MEMS”) devices that are configured to reflect or absorb incident light when in a first position and to transmit incident light when in a second position; and
capturing images via the light received by the light detector.

15. The method of claim 14, wherein the controlling process further comprises driving at least some of the MEMS devices to the second position for a predetermined period of time.

16. The method of claim 14, wherein the controlling process further comprises driving a predetermined number of the MEMS devices to the second position.

17. The method of claim 14, wherein the controlling process further comprises controlling the first array to transmit varying amounts of light.

18. The method of claim 15, further comprising:
detecting an ambient light intensity; and
calculating the predetermined period of time based, at least in part, on the ambient light intensity.

19. The method of claim 15, further comprising controlling the first array to function as a camera shutter.

20. The method of claim 16, further comprising controlling the first array to function as a variable camera aperture.

21. The method of claim 19, further comprising controlling the first array to function as a variable camera aperture.

22. The method of claim 19, further comprising controlling a second array to function as a variable camera aperture, the second array comprising a second plurality of MEMS devices.

23. The method of claim 20, further comprising controlling the first array of MEMS devices to function as a camera shutter.

24. The method of claim 20, further comprising controlling a second array to function as a camera shutter, the second array comprising a second plurality of MEMS devices.

25. A camera, comprising:
lens system means;
image capturing means configured to receive incoming light from the lens system means; and
light controlling means configured to reflect or absorb incident light when in a first position and to transmit incident light when in a second position.

26. The camera of claim 25, wherein the light controlling means comprises a first array configured to function as a camera shutter, the first array comprising a first plurality of MEMS devices.

27. The camera of claim 25, wherein the light controlling means comprises a first array configured to function as a variable camera aperture, the first array comprising a first plurality of MEMS devices.

28. The camera of claim 26, wherein the first array is further configured to function as a variable camera aperture.

29. The camera of claim 26, wherein the light controlling means comprises a second array configured to function as a variable camera aperture, the second array comprising a second plurality of MEMS devices.

30. The camera of claim 27, wherein the first array is further configured to function as a camera shutter.

31. The camera of claim 27, wherein the light controlling means comprises a second array configured to function as a camera shutter, the second array comprising a second plurality of MEMS devices.
